(19) United States
(12) Patent Application Publication
(10) Pub. No.: US 2018/0327592 A1
(43) Pub. Date: Nov. 15, 2018

(54) AMORPHOUS POLYAMIDE BASED COMPOSITION EXHIBITING AN IMPROVED DIMENSIONAL STABILITY

(71) Applicant: ARKEMA FRANCE, Colombes (FR)

(72) Inventors: Benoît Brule, Beaumont-le-Roger (FR); Benjamin Saillard, Bernay (FR); Karine Loyen, Pont-Audemer (FR); Philippe Blondel, Bernay (FR)

(21) Appl. No.: 15/776,497

(22) PCT Filed: Nov. 14, 2016
(86) PCT No.: PCT/EP2016/077535

§ 371 Date: May 16, 2018

(30) Foreign Application Priority Data
Nov. 17, 2015 (FR) 1561068

(51) Int. Cl. C08L 77/06; C08L 77/02; C08K 7/14

(52) U.S. Cl. CPC C08L 77/06; C08L 2205/025; C08K 7/14; C08L 77/02

(57) ABSTRACT

The application relates to a composition having improved dimensional stability and comprising an amorphous polyamide or a mixture of amorphous polyamides, and a semi-crystalline polyamide for which the average number of carbon atoms (C) relatively to the nitrogen atom (N) is greater than or equal to 8 or a mixture of semi-crystalline polyamides wherein the average number of carbon atoms (C) relatively to the nitrogen atom (N) of each of the semi-crystalline polyamides is greater than or equal to 8, to its preparation method and to its uses.

The present invention relates to a composition based on amorphous polyamide having improved dimensional stability at the temperature of use, in particular at room temperature, to its preparation methods and its uses.

Polyamide compositions have very many applications in industry for preparing articles or article elements.

Polymeric compositions and articles which consist of them absorb humidity from the surrounding medium, which causes a swelling of the compositions. These dimensional changes may be detrimental for certain applications, for which the dimensions of the parts have to be observed and notably should not vary overtime. These objects may in particular be obtained by the injection method.

Transparent amorphous polyamides may have dimensional stability less than that of other transparent amorphous polymers. For example, the water absorption rate measured according to the ISO 62 standard revised in 2011 at 23° C. in water of amorphous poly(methyl methacrylate) (PMMA) is 0.8%, that of polycarbonate is 0.35%, while that of polyamide 12/MACM.I/MACM.T is 3.3%.

The development of novel polyamide compositions based on amorphous polyamide having improved dimensional stability at room temperature is therefore required.

For this purpose, according to a first object, the invention relates to a composition comprising:
50 to 95% by weight, notably 60 to 90% by weight, preferably from 65 to 85% by weight of an amorphous polyamide or of a mixture of amorphous polyamides, and
5 to 50% by weight, notably 10 to 40% by weight, preferably from 15 to 35% by weight of a semi-crystalline polyamide for which the average number of carbon atoms (C) relatively to the nitrogen atom (N) is greater than or equal to 8 or of a mixture of semi-crystalline polyamides for which the average number of carbon atoms (C) relatively to the nitrogen atom (N) of each of the semi-crystalline polyamides is greater than or equal to 8,
   provided that when the amorphous polyamide is PA MACM.12 (B.12), the semi-crystalline polyamide is not a PA 12.

The concentration ranges have to be considered as including the limits.

The present invention is based on the discovery that the introduction of a semi-crystalline polyamide with a long chain (i.e. comprising an average number of carbon atoms (C) relatively to the nitrogen atom (N) is greater than or equal to 8) or of a mixture of semi-crystalline polyamides with a long chain in a composition based on amorphous polyamide, gives the possibility of reducing its water absorption rate and therefore of improving its dimensional stability.

An amorphous polyamide, in the sense of the invention, refers to an amorphous transparent polyamide only having a glassy transition temperature (no melting temperature (MP)), or a not very crystalline polyamide having a glassy transition temperature and a melting point such that the crystallization enthalpy during the cooling step at a rate of 20K/min in differential scanning calorimetry (DSC) measured according to the ISO 11357-3 standard as of 2013 is less than 30 J/g, notably less than 20 J/g, preferably less than 15 J/g. The glassy transition temperature (Tg) measured by DSC at a heating rate of 20K/min according to the ISO 11357-1 standard as of 2009 and ISO 11357-2 standard as of 2013 for these polyamides is greater than 75° C.

A semi-crystalline polyamide, in the sense of the invention, refers to a polyamide which has a melting temperature (MP) in DSC according to the ISO 11357-3 standard as of 2011, and a crystallization enthalpy during the cooling step at a rate of 20K/min in DSC measured according to the ISO 11357-3 standard as of 2013 greater than 30 J/g, preferably greater than 40 J/g.

Unless indicated otherwise, the embodiments below are independently applicable for the semi-crystalline polyamide and for the amorphous polyamide (or each of the amorphous polyamides when the composition comprises a mixture of amorphous polyamides, or each of the semi-crystalline polyamides when the composition comprises a mixture of semi-crystalline polyamides).

The polyamides used in the composition according to the invention comprise at least two identical or distinct recurrent units, these units may be formed from a dicarboxylic diacid and a diamine, from a diisocyanate and a carboxylic diacid, from an amino-acid, from a lactam or from mixtures thereof.

The polyamide may be a homopolyamide and comprise at least two identical recurrent units obtained from an amino acid, obtained from a lactam, or fitting the formula (Ca diamine).(Cb diacid), with a representing the number of carbon atoms of the diamine and b representing the number of carbon atoms of the diacid, a and b being each independently comprised between 4 and 36, as defined below. When the semi-crystalline polyamide is a homopolyamide comprising an amide unit fitting the formula (Ca diamine).(Cb diacid), the sum (a+b)/2 is greater than or equal to 8, preferably greater than or equal to 9, in particular greater than or equal to 10.

When the semi-crystalline polyamide is a homopolyamide:
obtained by polymerization of a amino acid or of a lactam, the number of carbon atoms of this amino acid or of this lactam is at least equal to 8, preferably greater than or equal to 9, in particular greater than or equal to 10,
comprising an amide unit fitting the formula (Ca diamine).(Cb diacid), the sum (a+b)/2 is greater than or equal to 8, preferably greater than or equal to 9, in particular greater than or equal to 10. Thus, the PA 6.12 is a PA with 9 carbon atoms per nitrogen atom, in other words a C9 PA. PA 6.13 is a C9.5 PA. PA 12.T is a C10 PA, T (terephthalic acid) being a C8 acid.

The polyamide may also be a copolyamide and comprise at least two distinct recurrent units, these units may be obtained independently from an amino acid, obtained from a lactam, obtained from a diisocyanate and a carboxylic diacid, or fitting the formula (Ca diamine).(Cb diacid), with a representing the number of carbon atoms of the diamine and b representing the number of carbon atoms of the diacid, a and b each being independently comprised between 4 and 36.

When the semi-crystalline polyamide is a copolyamide, the number of carbon atoms per nitrogen atom calculated in the molar proportion of the different amide units is at least equal to 8, preferably greater than or equal to 9, in particular greater than or equal to 10. In an embodiment, each of the amide units of the semi-crystalline polyamide has an average number of carbon atoms (C) relatively to the nitrogen atom (N) greater than or equal to 8, preferably greater than or equal to 9, in particular greater than or equal to 10. For example, the semi-crystalline polyamide may be a copolyamide comprising at least one unit obtained by polymerization of a lactam, the number of carbon atoms of this lactam being at least equal to 8, and at least one amide unit fitting the formula (Ca diamine).(Cb diacid), the sum (a+b)/2 being greater than or equal to 8.

In the case of copolyamides, the calculation of the number of carbon atoms per nitrogen atom is performed in the molar proportion of the different amide units.

The polyamide may comprise at least one unit obtained from an aminoacid selected from among 9-aminononanoic acid, 10-aminodecanoic acid, 12-aminododecanoic acid and 11-aminoundecanoic acid as well as its derivatives, notably N-heptyl-11-aminoundecanoic acid.

The polyamide may comprise at least one unit obtained from a lactam selected from among pyrrolidinone, piperidinone, caprolactam, enantholactam, caprylolactam, pelargolactam, decanolactam, undecanolactam, and laurolactam. Of course, if the semi-crystalline polyamide is a homopolyamide comprising a unit obtained from a lactam, the latter contains at least 8 carbon atoms, is therefore notably selected from among caprylolactam, pelargolactam, decanolactam, undecanolactam, and laurolactam.

The polyamide may comprise at least one unit fitting the formula (Ca diamine).(Cb diacid). The Ca diamine may be aliphatic (notably linear and aliphatic), cycloaliphatic or alkylaromatic. When the diamine is aliphatic and linear, the unit (diamine in Ca) has the formula H₂N—(CH₂)ₐ—NH₂. The Cb diacid may be aliphatic (notably aliphatic and linear), cycloaliphatic or aromatic.

Preferentially, when the Ca diamine is linear and aliphatic, it is selected from among butanediamine (a=4), pentanediamine (a=5), hexanediamine (a=6), heptanediamine (a=7), octanediamine (a=8), nonanediamine (a=9), decanediamine (a=10), undecanediamine (a=11), dodecanediamine (a=12), tridecanediamine (a=13), tetradecanediamine (a=14), hexadecanediamine (a=16), octadecanediamine (a=18), octadecanediamine (a=18), eicosanediamine (a=20), docosanediamine (a=22) and the diamines obtained from fatty acids.

When the Ca diamine is cycloaliphatic, it is preferably selected from among those comprising two rings. They notably fit the following general formula:

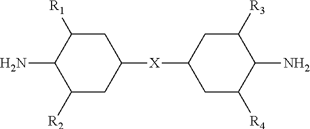

wherein:
R₁, R₂, R₃ and R₄ represent independently a group selected from among a hydrogen atom or an alkyl with 1 to 6 carbon atoms and
X represents either a simple bond, or a divalent group consisting of:
   a linear or branched aliphatic chain comprising from 1 to 10 carbon atoms, optionally substituted with cycloaliphatic or aromatic groups with 6 to 8 carbon atoms, or
   a cycloaliphatic group with 6 to 12 carbon atoms.
      More preferentially, the cycloaliphatic Ca diamine of the polyamide is selected from among bis(3,5-dialkyl-4-aminocyclohexyl)methane, bis(3,5-dialkyl-4-aminocyclohexyl) ethane, bis(3,5-dialkyl-4-aminocyclohexyl)propane, bis(3,5-dialkyl-4-aminocyclo-hexyl)butane, bis-(3-methyl-4-am inocyclohexyl)-methane (noted as BMACM, MACM or B), p-bis(aminocyclohexyl)-methane (PACM) and bis(aminocyclohexyl)propane (PACP) (2,2-bis(4-aminocyclohexyl) propane).

A non-exhaustive list of these cycloaliphatic diamines is given in the publication “Cycloaliphatic Amines” (Encyclopaedia of Chemical Technology, Kirk-Othmer, 4th Edition (1992), pp. 386-405).

Preferably, when the diamine is alkylaromatic, it is selected from among 1,3-xylylene diamine, 1,4-xylylene diamine and a mixture thereof.

Preferably, when the monomer (Cb diacid) is aliphatic and linear, it is selected from among succinic acid (b=4), pentanedioic acid (b=5), adipic acid (b=6), heptanedioic acid (b=7), octanedioic acid (b=8), azelaic acid (b=9), sebacic acid (b=10), undecanedioic acid (b=11), dodecanedioic acid (b=12), brassylic acid (b=13), tetradecanedioic acid (b=14), hexadecanedioic acid (b=16), octadecanoic acid (b=18), octadecenedioic acid (b=18), eicosanedioic acid (b=20), docosanedioic acid (b=22) and dimers of fatty acids containing 36 carbons.

Preferably, when the monomer (Cb diacid) is aromatic, it is selected from among terephthalic acid noted as T, isophthalic acid noted as I and naphthalenic diacid.

The fatty acid dimers mentioned above are dimerized fatty acids obtained by oligomerization or polymerization of unsaturated monobasic fatty acids with a long hydrocarbon chain (such as linoleic acid and oleic acid), as notably described in document EP 0 471 566.

When the diacid is cycloaliphatic, it may include the following carbon backbones: norbornylmethane, cyclohexylmethane, dicyclohexylmethane, dicyclohexylpropane, di(methylcyclohexyl) propane.

Except for N-heptyl-11-aminoundecanoic acid, the fatty acid dimers and the cycloaliphatic diamines described above are linear. However, the starting products for preparing the polyamide (aminoacids, diamines, diacids) may be completely or partly branched, such as 2-methyl-1,5-diaminopentane, or partly unsaturated. For example, the C18 carboxylic diacid may be octadecanedioic acid, which is saturated, or else octadecenedioic acid, which, as for it, has an unsaturation.

The nomenclature used for defining polyamides is described in the ISO 16396-1: 2015 standard «Plastics—Polyamide materials (PA) for molding and extrusion—Part 1: System for designating, marking the products and specification basis».

In an embodiment, the amorphous polyamide (or when the composition comprises a mixture of amorphous polyamides, at least one of the amorphous polyamides, or even each of the amorphous polyamides) comprises at least one unit fitting the formula (Ca diamine).(Cb diacid) or the Ca diamine as defined above and the Cb diacid is an aliphatic diacid (notably as defined above), the semi-crystalline polyamide (or when the composition comprises a mixture of semi-crystalline polyamides, at least one of the semi-crystalline polyamides, or even each of the semi-crystalline polyamides) being selected from among any of the polyamides defined above. This amorphous polyamide may be a homopolyamide or a copolyamide. For example, the Ca diamine is selected from among decanediamine (a=10), dodecanediamine (a=12), PACM and MACM and/or Cb diacid is selected from among sebacic acid (b=10), dodecanedioic acid (b=12), tetradecanedioic acid (b=14) and octadecanoic acid (b=18). Preferably, the amorphous polyamide (or when the composition comprises a mixture of amorphous polyamides, at least one of the amorphous polyamides, or even each of the amorphous polyamides) is PA MACM.10, PA PACM.10, PA MACM.12, PA PACM.12, PA MACM.14, PA PACM.14, PA MACM.18, PA PACM.18, PA 11/MACM.10, PA 11/PACM.10, PA 11/MACM.12, PA 11/PACM.12, PA 11/MACM.14, PA 11/PACM.14, PA 11/MACM.18, PA 11/PACM.18, PA 12/MACM.10, PA 12/PACM.10, PA 12/MACM.12, PA 12/PACM.12, PA 12/MACM.14, PA 12/PACM.14, PA 12/MACM.18, PA 12/PACM.18, PA 10.10/MACM.10, PA 10.10/PACM.10, PA 10.10/MACM.12, PA 10.10/PACM.12, PA 10.10/MACM.14, PA 10.10/PACM.14, PA 10.10/MACM.18, PA 10.10/PACM.18, PA 10.12/MACM.10, PA 10.12/PACM.10, PA 10.12/MACM.12, PA 10.12/PACM.12, PA 10.12/MACM.14, PA 10.12/PACM.14, PA 10.12/MACM.18, PA 10.12/PACM.18, PA 12.10/MACM.10, PA 12.10/PACM.10, PA 12.10/MACM.12, PA 12.10/PACM.12, PA 12.10/MACM.14, PA 12.10/PACM.14, PA 12.10/MACM.18, PA 12.10/PACM.18, PA 12.12/MACM.10, PA 12.12/PACM.10, PA 12.12/MACM.12, PA 12.12/PACM.12, PA 12.12/MACM.14, PA 12.12/PACM.14, PA 12.12/MACM.18, PA 12.12/PACM.18, PA 10.14/PACM.10, PA 10.14/MACM.12, PA 10.14/PACM.12, PA 10.14/MACM.14, PA 10.14/PACM.14, PA 10.14/MACM.18, PA 10.14/PACM.18, PA 12.14/MACM.10, PA 12.14/PACM.10, PA 12.14/MACM.12, PA 12.14/PACM.12, PA 12.14/MACM.14, PA 12.14/PACM.14, PA 12.14/MACM.18, PA 12.14/PACM.18, PA PACM.10/MACM.10, PA PACM.12/MACM.12, PA PACM.14/MACM.14, PA 11/PACM.10/MACM.10, PA 11/PACM.12/MACM.12, PA 11/PACM.14/MACM.14, PA 12/PACM.10/MACM.10, PA 12/PACM.12/MACM.12, or PA 12/PACM.14/MACM.14. The amorphous polyamide (or when the composition comprises a mixture of amorphous polyamides, at least one of the amorphous polyamides, or even each of the amorphous polyamides) may for example be PA MACM.10, PA MACM.12, PA MACM.14, or PA Z/MACM.10, PA Z/MACM.12, PA Z/MACM.14, wherein Z represents 11, 12, 10.10 or 10.12 or a polyamide as described in patent application EP 1 595 907.

In an embodiment, the amorphous polyamide (or when the composition comprises a mixture of amorphous polyamides, at least one of the amorphous polyamides, or even each of the amorphous polyamides) comprises at least one unit fitting the formula (Ca diamine).(Cb diacid) or the Ca diamine is cycloaliphatic (notably as defined above) and the Cb diacid is as defined above, the semi-crystalline polyamide (or when the composition comprises a mixture of semi-crystalline polyamides, at least one of the semi-crystalline polyamides, or even each of the semi-crystalline polyamides) being selected from among any of the polyamides defined above. For example, the Ca diamine is PACM or MACM and/or the Cb diacid is selected from among sebacic acid (b=10), dodecanedioic acid (b=12), tetradecanedioic acid (b=14) and octadecanoic acid (b=18). This amorphous polyamide (or when the composition comprises a mixture of amorphous polyamides, at least one of the amorphous polyamides, or even each of the amorphous polyamides) may be a homopolyamide or a copolyamide. Preferably, the amorphous polyamide (or when the composition comprises a mixture of amorphous polyamides, at least one of the amorphous polyamides, or even each of the amorphous polyamides) is.

Preferably, the amorphous polyamide (or when the composition comprises a mixture of amorphous polyamides, at least one of the amorphous polyamides, or even each of the amorphous polyamides) is PA MACM.10, PA PACM.10, PA MACM.12, PA PACM.12, PA MACM.14, PA PACM.14, PA MACM.18, PA PACM.18, PA 11/MACM.10, PA 11/PACM.10, PA 11/MACM.12, PA 11/PACM.12, PA 11/MACM.14, PA 11/PACM.14, PA 11/MACM.18, PA 11/PACM.18, PA 12/MACM.10, PA 12/PACM.10, PA 12/MACM.12, PA 12/PACM.12, PA 12/MACM.14, PA 12/PACM.14, PA 12/MACM.18, PA 12/PACM.18, PA 10.10/MACM.10, PA 10.10/PACM.10, PA 10.10/MACM.12, PA 10.10/PACM.12, PA 10.10/MACM.14, PA 10.10/PACM.14, PA 10.10/MACM.18, PA 10.10/PACM.18, PA 10.12/MACM.10, PA 10.12/PACM.10, PA 10.12/MACM.12, PA 10.12/PACM.12, PA 10.12/MACM.14, PA 10.12/PACM.14, PA 10.12/MACM.18, PA 10.12/PACM.18, PA 12.10/MACM.10, PA 12.10/PACM.10, PA 12.10/MACM.12, PA 12.10/PACM.12, PA 12.10/MACM.14, PA 12.10/PACM.14, PA 12.10/MACM.18, PA 12.10/PACM.18, PA 12.12/MACM.10, PA 12.12/PACM.10, PA 12.12/MACM.12, PA 12.12/PACM.12, PA 12.12/MACM.14, PA 12.12/PACM.14, PA 12.12/MACM.18, PA 12.12/PACM.18, PA 10.14/PACM.10, PA 10.14/MACM.12, PA 10.14/PACM.12, PA 10.14/MACM.14, PA 10.14/PACM.14, PA 10.14/MACM.18, PA 10.14/PACM.18, PA 12.14/MACM.10, PA 12.14/PACM.10, PA 12.14/MACM.12, PA 12.14/PACM.12, PA 12.14/MACM.14, PA 12.14/PACM.14, PA 12.14/MACM.18, PA 12.14/PACM.18, PA PACM.10/MACM.10, PA PACM.12/MACM.12, PA PACM.14/MACM.14, PA 11/PACM.10/MACM.10, PA 11/PACM.12/MACM.12, PA 11/PACM.14/MACM.14, PA 12/PACM.10/MACM.10, PA 12/PACM.12/MACM.12, PA 12/PACM.14/MACM.14, PA MACM.I, PA PACM.I, PA MACM.I/MACM.T, PA PACM.I/PACM.T, PA 12/MACM.I, PA 12/PACM.I, PA 12/MACM.I/MACM.T, PA 12/PACM.I/PACM.T, PA 11/MACM.I, PA 11/PACM.I, PA 11/MACM.I/MACM.T, PA 11/PACM.I/PACM.T, 10.10/MACM.I, 10.10/PACM.I, PA 10.10/MACM.I/MACM.T, 10.10/PACM.I/PACM.T, 10.12/MACM.I, 10.12/PACM.I, PA 10.12/MACM.I/MACM.T, 10.12/PA PACM.I/PACM.T, 12.10/MACM.I, 12.10/PA PACM.I, PA 12.10/MACM.I/MACM.T, 12.10/PACM.I/PACM.T, 12.12/MACM.I, 12.12/PACM.I, PA 12.12/MACM.I/MACM.T, 12.12/PACM.I/PACM.T, 12.14/MACM.I, 12.14/PACM.I, PA 12.14/MACM.I/MACM.T, 12.14/PACM.I/PACM.T, 10.14/MACM.I, 10.14/PACM.I, PA 10.14/MACM.I/MACM.T or 10.14/PACM.I/PACM.T. The amorphous polyamide (or when the composition comprises a mixture of amorphous polyamides, at least one of the amorphous polyamides, or even each of the amorphous polyamides) may for example be PA MACM.10, PA MACM.12, PA MACM.14, PA Z/MACM.10, PA Z/MACM.12, PA Z/MACM.14, PA Z/MACM.I or PA Z/MACM.I/MACM.T wherein Z represents 11, 12, 10.10 or 10.12, or a copolyamide as described in patent application WO 2009/153534.

In an embodiment, the amorphous polyamide (or when the composition comprises a mixture of amorphous polyamides, at least one of the amorphous polyamides, or even each of the amorphous polyamides) comprises at least one unit fitting the formula (Ca diamine).(Cb diacid) or Ca diamine is such as defined above and the Cb diacid is an aromatic diacid (notably as defined above), the semi-crystalline polyamide (or when the composition comprises a mixture of semi-crystalline polyamides, at least one of the semi-crystalline polyamides, or even each of the semi-crystalline polyamides) being selected from among any of the polyamides defined above.

In an embodiment, the amorphous polyamide (or when the composition comprises a mixture of amorphous polyamides, at least one of the amorphous polyamides, or even each of the amorphous polyamides) comprises at least one unit fitting the formula (Ca diamine).(Cb diacid) wherein the Ca diamine is cycloaliphatic (notably as defined above) and the Cb diacid is an aromatic diacid (notably as defined above), the semi-crystalline polyamide (or when the composition comprises a mixture of semi-crystalline polyamides, at least one of the semi-crystalline polyamides, or even each of the semi-crystalline polyamides) being selected from among any of the polyamides defined above. For example, the Ca diamine is PACM or MACM and/or the Cb diacid is terephthalic acid or isophthalic acid. This amorphous polyamide may be a homopolyamide or a copolyamide. Preferably, the amorphous polyamide (or when the composition comprises a mixture of amorphous polyamides, at least one of the amorphous polyamides, or even each of the amorphous polyamides) is PA MACM.I, PA PACM.I, PA MACM.I/MACM.T, PA PACM.I/PACM.T, PA 12/MACM.I, PA 12/PACM.I, PA 12/MACM.I/MACM.T, PA 12/PACM.I/PACM.T, PA 11/MACM.I, PA 11/PACM.I, PA 11/MACM.I/MACM.T, PA 11/PACM.I/PACM.T, 10.10/MACM.I, 10.10/PACM.I, PA 10.10/MACM.I/MACM.T, 10.10/PACM.I/PACM.T, 10.12/MACM.I, 10.12/PACM.I, PA 10.12/MACM.I/MACM.T, 10.12/PA PACM.I/PACM.T, 12.10/MACM.I, 12.10/PA PACM.I, PA 12.10/MACM.I/MACM.T, 12.10/PACM.I/PACM.T, 12.12/MACM.I, 12.12/PACM.I, PA 12.12/MACM.I/MACM.T, 12.12/PACM.I/PACM.T, 12.14/MACM.I, 12.14/PACM.I, PA 12.14/MACM.I/MACM.T, 12.14/PACM.I/PACM.T, 10.14/MACM.I, 10.14/PACM.I, PA 10.14/MACM.I/MACM.T or 10.14/PACM.I/PACM.T. The amorphous polyamide (or when the composition comprises a mixture of amorphous polyamides, at least one of the amorphous polyamides, or even each of the amorphous polyamides) may for example be PA Z/MACM.I or PA Z/MACM.I/MACM.T wherein Z represents 11, 12, 10.10 or 10.12.

In an embodiment, the amorphous polyamide (or when the composition comprises a mixture of amorphous polyamides, at least one of the amorphous polyamides, or even each of the amorphous polyamides) comprises at least one unit fitting the formula (Ca diamine).(Cb diacid) wherein the Ca diamine is cycloaliphatic (notably as defined above) and the Cb diacid is an aliphatic diacid (notably as defined above), the semi-crystalline polyamide (or when the composition comprises a mixture of semi-crystalline polyamides, at least one of the semi-crystalline polyamides, or even each of the semi-crystalline polyamides) being selected from among any of the polyamides defined above. For example, the Ca diamine is PACM or MACM and/or the Cb diacid is sebacic acid (b=10), dodecanedioic acid (b=12), tetradecanedioic acid (b=14) or octadecanoic acid (b=18). This amorphous polyamide may be a homopolyamide or a copolyamide. Preferably, the amorphous polyamide (or when the composition comprises a mixture of amorphous polyamides, at least one of the amorphous polyamides, or even each of the amorphous polyamides) is PA MACM.10, PA PACM.10, PA MACM.12, PA PACM.12, PA MACM.14, PA PACM.14, PA MACM.18, PA PACM.18, PA 11/MACM.10, PA 11/PACM.10, PA 11/MACM.12, PA 11/PACM.12, PA 11/MACM.14, PA 11/PACM.14, PA 11/MACM.18, PA 11/PACM.18, PA 12/MACM.10, PA 12/PACM.10, PA 12/MACM.12, PA 12/PACM.12, PA 12/MACM.14, PA 12/PACM.14, PA 12/MACM.18, PA 12/PACM.18, PA 10.10/MACM.10, PA 10.10/PACM.10, PA 10.10/MACM.12, PA 10.10/PACM.12, PA 10.10/MACM.14, PA 10.10/PACM.14, PA 10.10/MACM.18, PA 10.10/PACM.18, PA 10.12/MACM.10, PA 10.12/PACM.10, PA 10.12/MACM.12, PA 10.12/PACM.12, PA 10.12/MACM.14, PA 10.12/PACM.14, PA 10.12/MACM.18, PA 10.12/PACM.18, PA 12.10/MACM.10, PA 12.10/PACM.10, PA 12.10/MACM.12, PA 12.10/PACM.12, PA 12.10/MACM.14, PA 12.10/PACM.14, PA 12.10/MACM.18, PA 12.10/PACM.18, PA 12.12/MACM.10, PA 12.12/PACM.10, PA 12.12/MACM.12, PA 12.12/PACM.12, PA 12.12/MACM.14, PA 12.12/PACM.14, PA 12.12/MACM.18, PA 12.12/PACM.18, PA 10.14/PACM.10, PA 10.14/MACM.12, PA 10.14/PACM.12, PA 10.14/MACM.14, PA 10.14/PACM.14, PA 10.14/MACM.18, PA 10.14/PACM.18, PA 12.14/MACM.10, PA 12.14/PACM.10, PA 12.14/MACM.12, PA 12.14/PACM.12, PA 12.14/MACM.14, PA 12.14/PACM.14, PA 12.14/MACM.18, PA 12.14/PACM.18, PA PACM.10/MACM.10, PA PACM.12/MACM.12, PA PACM.14/MACM.14, PA 11/PACM.10/MACM.10, PA 11/PACM.12/MACM.12, PA 11/PACM.14/MACM.14, PA 12/PACM.10/MACM.10, PA 12/PACM.12/MACM.12, or PA 12/PACM.14/MACM.14. The amorphous polyamide (or when the composition comprises a mixture of amorphous polyamides, at least one of the amorphous polyamides, or even each of the amorphous polyamides) may for example be PA MACM.10, PA MACM.12, PA MACM.14, or PA Z/MACM.10, PA Z/MACM.12, PA Z/MACM.14, wherein Z represents 11, 12, 10.10 or 10.12.

In an embodiment, the amorphous polyamide (or when the composition comprises a mixture of amorphous polyamides, at least one of the amorphous polyamides, or even each of the amorphous polyamides) is a copolyamide, the semi-crystalline polyamide (or when the composition comprises a mixture of semi-crystalline polyamides, at least one of the semi-crystalline polyamides, or even each of the semi-crystalline polyamides) being selected from among any of the polyamides defined above. Preferably, the amorphous polyamide (or when the composition comprises a mixture of amorphous polyamides, at least one of the amorphous polyamides, or even each of the amorphous polyamides) is PA MACM.I/MACM.T, PA PACM.I/PACM.T, PA 12/MACM.I, PA 12/PACM.I, PA 12/MACM.I/MACM.T, PA 12/PACM.I/PACM.T, PA 11/MACM.I, PA 11/PACM.I, PA 11/MACM.I/MACM.T, PA 11/PACM.I/PACM.T, 10.10/MACM.I, 10.10/PACM.I, PA 10.10/MACM.I/MACM.T, 10.10/PACM.I/PACM.T, 10.12/MACM.I, 10.12/PACM.I, PA 10.12/MACM.I/MACM.T, 10.12/PACM.I/PACM.T, 12.10/MACM.I, 12.10/PACM.I, PA 12.10/MACM.I/MACM.T, 12.10/PACM.I/PACM.T, 12.12/MACM.I, 12.12/PACM.I, PA 12.12/MACM.I/MACM.T, 12.12/PACM.I/PACM.T, 12.14/MACM.I, 12.14/PACM.I, PA 12.14/MACM.I/MACM.T, 12.14/PACM.I/PACM.T, 10.14/MACM.I, 10.14/PACM.I, PA 10.14/MACM.I/MACM.T, 10.14/PACM.I/PACM.T, PA 11/MACM.10, PA 11/PACM.10, PA 11/MACM.12, PA 11/PACM.12, PA 11/MACM.14, PA 11/PACM.14, PA 11/MACM.18, PA 11/PACM.18, PA 12/MACM.10, PA 12/PACM.10, PA 12/MACM.12, PA 12/PACM.12, PA 12/MACM.14, PA 12/PACM.14, PA 12/MACM.18, PA 12/PACM.18, PA 10.10/MACM.10, PA 10.10/PACM.10, PA 10.10/MACM.12, PA 10.10/PACM.12, PA 10.10/MACM.14, PA 10.10/PACM.14, PA 10.10/MACM.18, PA 10.10/PACM.18, PA 10.12/MACM.10, PA 10.12/PACM.10, PA 10.12/MACM.12, PA 10.12/PACM.12, PA 10.12/MACM.14, PA 10.12/PACM.14, PA 10.12/MACM.18, PA 10.12/PACM.18, PA 12.10/MACM.10, PA 12.10/PACM.10, PA 12.10/MACM.12, PA 12.10/PACM.12, PA 12.10/MACM.14, PA 12.10/PACM.14, PA 12.10/MACM.18, PA 12.10/PACM.18, PA 12.12/MACM.10, PA 12.12/PACM.10, PA 12.12/MACM.12, PA 12.12/PACM.12, PA 12.12/MACM.14, PA 12.12/PACM.14, PA 12.12/MACM.18, PA 12.12/PACM.18, PA 10.14/PACM.10, PA 10.14/MACM.12, PA 10.14/PACM.12, PA 10.14/MACM.14, PA 10.14/PACM.14, PA 10.14/MACM.18, PA 10.14/PACM.18, PA 12.14/MACM.10, PA 12.14/PACM.10, PA 12.14/MACM.12, PA 12.14/PACM.12, PA 12.14/MACM.14, PA 12.14/PACM.14, PA 12.14/MACM.18, PA 12.14/PACM.18, PA PACM.10/MACM.10, PA PACM.12/MACM.12, PA PACM.14/MACM.14, PA 11/PACM.10/MACM.10, PA 11/PACM.12/MACM.12, PA 11/PACM.14/MACM.14, PA 12/PACM.10/MACM.10, PA 12/PACM.12/MACM.12 or PA 12/PACM.14/MACM.14. The amorphous polyamide (or when the composition comprises a mixture of amorphous polyamides, at least one of the amorphous polyamides, or even each of the amorphous polyamides) may for example be PA Z/MACM.10, PA Z/MACM.12, PA Z/MACM.14, PA Z/MACM.I or PA Z/MACM.I/MACM.T wherein Z represents 11, 12, 10.10 or 10.12, or a copolyamide as described in patent application WO 2009/153534.

In an embodiment, the amorphous polyamide (or when the composition comprises a mixture of amorphous polyamides, at least one of the amorphous polyamides, or even each of the amorphous polyamides) is a copolyamide comprising:
at least one unit obtained from of a lactam or an amino acid, and
at least one unit fitting the formula (Ca diamine).(Cb diacid), in which the Ca diamine and Cb diacid are as defined above, the semi-crystalline polyamide (or when the composition comprises a mixture of semi-crystalline polyamides, at least one of the semi-crystalline polyamides, or even each of the semi-crystalline polyamides) being selected from among any of the polyamides defined above. The amorphous polyamide (or when the composition comprises a mixture of amorphous polyamides, at least one of the amorphous polyamides, or even each of the amorphous polyamides) may for example be PA Z/MACM.10, PA Z/MACM.12, PA Z/MACM.14, PA Z/MACM.I or PA Z/MACM.I/MACM.T, wherein Z represents 11 or 12. For example, the lactam is the laurolactam or the amino acid is 11-aminoundecanoic acid and/or the Ca diamine is selected from among decanediamine (a=10), dodecanediamine (a=12), PACM and MACM and/or the Cb diacid is selected from among sebacic acid (b=10), dodecanedioic acid (b=12), tetradecanedioic acid (b=14), octadecanoic acid (b=18), terephthalic acid and isophthalic acid. Preferably, the amorphous polyamide (or when the composition comprises a mixture of amorphous polyamides, at least one of the amorphous polyamides, or even each of the amorphous polyamides) is PA 12/MACM.I, PA 12/PACM.I, PA 12/MACM.I/MACM.T, PA 12/PACM.I/PACM.T, PA 11/MACM.I, PA 11/PACM.I, PA 11/MACM.I/MACM.T, PA 11/PACM.I/PACM.T, PA 11/MACM.10, PA 11/PACM.10, PA 11/MACM.12, PA 11/PACM.12, PA 11/MACM.14, PA 11/PACM.14, PA 11/MACM.18, PA 11/PACM.18, PA 12/MACM.10, PA 12/PACM.10, PA 12/MACM.12, PA 12/PACM.12, PA 12/MACM.14, PA 12/PACM.14, PA 12/MACM.18, PA 12/PACM.18, PA 11/PACM.10/MACM.10, PA 11/PACM.12/MACM.12, PA 11/PACM.14/MACM.14, PA 12/PACM.10/MACM.10, PA 12/PACM.12/MACM.12, or PA 12/PACM.14/MACM.14.

In an embodiment, the amorphous polyamide (or when the composition comprises a mixture of amorphous polyamides, at least one of the amorphous polyamides, or even each of the amorphous polyamides) is a copolyamide comprising:
at least one unit obtained from a lactam or an amino acid, and
at least one unit fitting the formula (Ca diamine).(Cb diacid), or the Ca diamine is cycloaliphatic (notably as defined above) and the Cb diacid is an aromatic diacid (notably as defined above),
   the semi-crystalline polyamide (or when the composition comprises a mixture of semi-crystalline polyamides, at least one of the semi-crystalline polyamides, or even each of the semi-crystalline polyamides) being selected from among any of the polyamides defined above. The amorphous polyamide (or when the composition comprises a mixture of amorphous polyamides, at least one of the amorphous polyamides, or even each of the amorphous polyamides) may for example be PA Z/MACM.I or PA Z/MACM.I/MACM.T wherein Z represents 11 or 12. For example, the lactam is the laurolactam or the amino acid is 11-aminoundecanoic acid and/or the Ca diamine is selected from among PACM and MACM and/or the Cb diacid is selected from terephthalic acid and isophthalic acid. Preferably, the amorphous polyamide (or when the composition comprises a mixture of amorphous polyamides, at least one of the amorphous polyamides, or even each of the amorphous polyamides) is PA 12/MACM.I, PA 12/PACM.I, PA 12/MACM.I/MACM.T, PA 12/PACM.I/PACM.T, PA 11/MACM.I, PA 11/PACM.I, PA 11/MACM.I/MACM.T, or PA 11/PACM.I/PACM.T.

In an embodiment, the amorphous polyamide (or when the composition comprises a mixture of amorphous polyamides, at least one of the amorphous polyamides, or even each of the amorphous polyamides) is a copolyamide comprising:
at least one unit obtained from a lactam, and
at least one unit fitting the formula (Ca diamine).(Cb diacid), wherein the Ca diamine is cycloaliphatic (notably as defined above) and the Cb diacid is an aromatic diacid (notably as defined above),
   and is a polyamide PA A/Ca.Cb wherein A is a lactam. For example, the lactam is the laurolactam and/or the Ca diamine is selected from among PACM and MACM and/or the Cb diacid is selected from among terephthalic acid and isophthalic acid.

In an embodiment, the amorphous polyamide (or when the composition comprises a mixture of amorphous polyamides, at least one of the amorphous polyamides, or even each of the amorphous polyamides) is a copolyamide comprising:
at least one unit obtained from an amino acid, and
at least one unit fitting the formula (Ca diamine).(Cb diacid), wherein the Ca diamine is cycloaliphatic (notably as defined above) and the Cb diacid is an aromatic diacid (notably as defined above), and
   and is a polyamide PA A/Ca.Cb wherein A is an amino acid. For example, the amino acid is 11-aminoundecanoic acid and/or the Ca diamine is selected from among PACM and MACM and/or the Cb diacid is selected from terephthalic acid and isophthalic acid.

In an embodiment, the amorphous polyamide (or when the composition comprises a mixture of amorphous polyamides, at least one of the amorphous polyamides, or even each of the amorphous polyamides) is a copolyamide comprising:
at least one unit fitting the formula (Ca′ diamine).(Cb′ diacid), wherein the Ca′ diamine is selected from among one of the Ca diamines defined above and the Cb′ diacid is selected from one of the Cb diacids defined above and
at least one unit fitting the formula (Ca diamine).(Cb diacid), wherein the Ca diamine is cycloaliphatic (notably as defined above) and the Cb diacid is an aromatic diacid (notably as defined above),
   provided that the (Ca diamine).(Cb diacid) is different from (Ca′ diamine).(Cb′ diacid), and is a polyamide PA Ca′.Cb′/Ca.Cb. For example, the Ca′ diamine is selected from among decanediamine (a=10), dodecanediamine (a=12), PACM and MACM and/or Cb′ diacid is selected from among sebacic acid (b=10), dodecanedioic acid (b=12), tetradecanedioic acid (b=14), octadecanoic acid (b=18), terephthalic acid and isophthalic acid and/or the Ca diamine is selected from among PACM and MACM and/or the Cb diacid is selected from among terephthalic acid and isophthalic cid.

In an embodiment, the amorphous polyamide (or when the composition comprises a mixture of amorphous polyamides, at least one of the amorphous polyamides, or even each of the amorphous polyamides) is a copolyamide comprising:
at least one unit obtained from a lactam or an amino acid, and
at least one unit fitting the formula (Ca diamine).(Cb diacid), wherein the Ca diamine is cycloaliphatic (notably as defined above) and the Cb diacid is an aliphatic diacid (notably as defined above),
   the semi-crystalline polyamide (or when the composition comprises a mixture of semi-crystalline polyamides, at least one of the semi-crystalline polyamides, or even each of the semi-crystalline polyamides) being selected from among any of the polyamides defined above. The amorphous polyamide (or when the composition comprises a mixture of amorphous polyamides, at least one of the amorphous polyamides, or even each of the amorphous polyamides) may for example be PA Z/MACM.10, PA Z/MACM.12, PA Z/MACM.14, wherein Z represents 11 or 12. For example, the lactam is the laurolactam or the amino acid is 11-aminoundecanoic acid and/or the Ca diamine is selected from among PACM and MACM and/or the Cb diacid is selected from among sebacic acid (b=10), dodecanedioic acid (b=12), tetradecanedioic acid (b=14) and octadecanoic acid (b=18). Preferably, the amorphous polyamide (or when the composition comprises a mixture of amorphous polyamides, at least one of the amorphous polyamides, or even each of the amorphous polyamides) is PA 11/MACM.10, PA 11/PACM.10, PA 11/MACM.12, PA 11/PACM.12, PA 11/MACM.14, PA 11/PACM.14, PA 11/MACM.18, PA 11/PACM.18, PA 12/MACM.10, PA 12/PACM.10, PA 12/MACM.12, PA 12/PACM.12, PA 12/MACM.14, PA 12/PACM.14, PA 12/MACM.18, PA 12/PACM.18, PA 11/PACM.10/MACM.10, PA 11/PACM.12/MACM.12, PA 11/PACM.14/MACM.14, PA 12/PACM.10/MACM.10, PA 12/PACM.12/MACM.12 or PA 12/PACM.14/MACM.14.

In an embodiment, the amorphous polyamide (or when the composition comprises a mixture of amorphous polyamides, at least one of the amorphous polyamides, or even each of the amorphous polyamides) is a copolyamide comprising:
at least one unit fitting the formula (Ca diamine).(Cb diacid) wherein the Ca diamine is aliphatic (notably as defined above) and the Cb diacid is an aliphatic diacid (notably as defined above), and
at least one unit fitting the formula (Ca′ diamine).(Cb′ diacid), wherein the Ca′ diamine is selected from among one of the Ca diamines defined above and the Cb′ diacid is selected from among one of the Cb diacids defined above,
   provided that (Ca diamine).(Cb diacid) is different from (Ca′ diamine).(Cb′ diacid), the semi-crystalline polyamide (or when the composition comprises a mixture of semi-crystalline polyamides, at least one of the semi-crystalline polyamides, or even each of the semi-crystalline polyamides) being selected from among any of the polyamides defined above. For example, the Ca diamine is selected from among decanediamine (a=10) and dodecanediamine (a=12) and/or the Cb diacid is selected from sebacic acid (b=10), dodecanedioic acid (b=12), tetradecanedioic acid (b=14) and octadecanoic acid (b=18), and/or the Ca′ diamine is selected from among decanediamine (a=10) and dodecanediamine (a=12), PACM and MACM and/or the Cb′ diacid is selected from among sebacic acid (b=10), dodecanedioic acid (b=12), tetradecanedioic acid (b=14), octadecanoic acid (b=18), terephthalic acid and isophthalic acid. Preferably, the amorphous polyamide (or when the composition comprises a mixture of amorphous polyamides, at least one of the amorphous polyamides, or even each of the amorphous polyamides) is 10.10/MACM.I, 10.10/PACM.I, PA 10.10/MACM.I/MACM.T, 10.10/PACM.I/PACM.T, 10.12/MACM.I, 10.12/PACM.I, PA 10.12/MACM.I/MACM.T, 10.12/PACM.I/PACM.T, 12.10/MACM.I, 12.10/PACM.I, PA 12.10/MACM.I/MACM.T, 12.10/PACM.I/PACM.T, 12.12/MACM.I, 12.12/PACM.I, PA 12.12/MACM.I/MACM.T, 12.12/PACM.I/PACM.T, 12.14/MACM.I, 12.14/PACM.I, PA 12.14/MACM.I/MACM.T, 12.14/PACM.I/PACM.T, 10.14/MACM.I, 10.14/PACM.I, PA 10.14/MACM.I/MACM.T, 10.14/PACM.I/PACM.T, PA 10.10/MACM.10, PA 10.10/PACM.10, PA 10.10/MACM.12, PA 10.10/PACM.12, PA 10.10/MACM.14, PA 10.10/PACM.14, PA 10.10/MACM.18, PA 10.10/PACM.18, PA 10.12/MACM.10, PA 10.12/PACM.10, PA 10.12/MACM.12, PA 10.12/PACM.12, PA 10.12/MACM.14, PA 10.12/PACM.14, PA 10.12/MACM.18, PA 10.12/PACM.18, PA 12.10/MACM.10, PA 12.10/PACM.10, PA 12.10/MACM.12, PA 12.10/PACM.12, PA 12.10/MACM.14, PA 12.10/PACM.14, PA 12.10/MACM.18, PA 12.10/PACM.18, PA 12.12/MACM.10, PA 12.12/PACM.10, PA 12.12/MACM.12, PA 12.12/PACM.12, PA 12.12/MACM.14, PA 12.12/PACM.14, PA 12.12/MACM.18, PA 12.12/PACM.18, PA 10.14/PACM.10, PA 10.14/MACM.12, PA 10.14/PACM.12, PA 10.14/MACM.14, PA 10.14/PACM.14, PA 10.14/MACM.18, PA 10.14/PACM.18, PA 12.14/MACM.10, PA 12.14/PACM.10, PA 12.14/MACM.12, PA 12.14/PACM.12, PA 12.14/MACM.14, PA 12.14/PACM.14, PA 12.14/MACM.18 or PA 12.14/PACM.18.

In an embodiment, the amorphous polyamide (or when the composition comprises a mixture of amorphous polyamides, at least one of the amorphous polyamides, or even each of the amorphous polyamides) is a copolyamide comprising:
at least one unit fitting the formula (Ca diamine).(Cb diacid) wherein the Ca diamine is aliphatic (notably as defined above) and the Cb diacid is an aliphatic diacid (notably as defined above), and
at least one unit fitting the formula (Ca′ diamine).(Cb′ diacid), wherein the Ca′ diamine is selected from among one of the cycloaliphatic Ca diamines defined above and the Cb′ diacid is selected from among one of the aromatic Cb diacids defined above,
   the semi-crystalline polyamide (or when the composition comprises a mixture of semi-crystalline polyamides, at least one of the semi-crystalline polyamides, or even each of the semi-crystalline polyamides) being selected from among any of the polyamides defined above. For example, the Ca diamine is selected from among decanediamine (a=10) and dodecanediamine (a=12) and/or the Cb diacid is selected from among sebacic acid (b=10), dodecanedioic acid (b=12), tetradecanedioic acid (b=14) and octadecanoic acid (b=18), and/or the Ca′ diamine is selected from among PACM and MACM and/or the Cb′ diacid is selected from among terephthalic acid and isophthalic acid. Preferably, the amorphous polyamide (or when the composition comprises a mixture of amorphous polyamides, at least one of the amorphous polyamides, or even each of the amorphous polyamides) is 10.10/MACM.I, 10.10/PACM.I, PA 10.10/MACM.I/MACM.T, 10.10/PACM.I/PACM.T, 10.12/MACM.I, 10.12/PACM.I, PA 10.12/MACM.I/MACM.T, 10.12/PACM.I/PACM.T, 12.10/MACM.I, 12.10/PACM.I, PA 12.10/MACM.I/MACM.T, 12.10/PACM.I/PACM.T, 12.12/MACM.I, 12.12/PACM.I, PA 12.12/MACM.I/MACM.T, 12.12/PACM.I/PACM.T, 12.14/MACM.I, 12.14/PACM.I, PA 12.14/MACM.I/MACM.T, 12.14/PACM.I/PACM.T, 10.14/MACM.I, 10.14/PACM.I, PA 10.14/MACM.I/MACM.T or 10.14/PACM.I/PACM.T.

In an embodiment, the amorphous polyamide (or when the composition comprises a mixture of amorphous polyamides, at least one of the amorphous polyamides, or even each of the amorphous polyamides) is a copolyamide comprising:
at least one unit fitting the formula (Ca diamine).(Cb diacid) wherein the Ca diamine is aliphatic (notably as defined above) and the Cb diacid is an aliphatic diacid (notably as defined above), and
at least one unit fitting the formula (Ca′ diamine).(Cb′ diacid), wherein the Ca′ diamine is selected from among one of the cycloaliphatic Ca diamines defined above and the Cb′ diacid is selected from among one of the aliphatic Cb diacids defined above,
   provided that (Ca diamine).(Cb diacid) is different from (Ca′ diamine).(Cb′ diacid), the semi-crystalline polyamide (or when the composition comprises a mixture of semi-crystalline polyamides, at least one of the semi-crystalline polyamides, or even each of the semi-crystalline polyamides) being selected from among any of the polyamides defined above. For example, the Ca diamine is selected from among decanediamine (a=10) and dodecanediamine (a=12) and/or the Cb diacid is selected from among sebacic acid (b=10), dodecanedioic acid (b=12), tetradecanedioic acid (b=14) and octadecanoic acid (b=18), and/or the Ca′ diamine is selected from among PACM and MACM and/or the Cb′ diacid is selected from among sebacic acid (b=10), dodecanedioic acid, tetradecanedioic acid (b=14) and octadecanoic acid (b=18). Preferably, the amorphous polyamide (or when the composition comprises a mixture of amorphous polyamides, at least one of the amorphous polyamides, or even each of the amorphous polyamides) is PA 10.10/MACM.10, PA 10.10/PACM.10, PA 10.10/MACM.12, PA 10.10/PACM.12, PA 10.10/MACM.14, PA 10.10/PACM.14, PA 10.10/MACM.18, PA 10.10/PACM.18, PA 10.12/MACM.10, PA 10.12/PACM.10, PA 10.12/MACM.12, PA 10.12/PACM.12, PA 10.12/MACM.14, PA 10.12/PACM.14, PA 10.12/MACM.18, PA 10.12/PACM.18, PA 12.10/MACM.10, PA 12.10/PACM.10, PA 12.10/MACM.12, PA 12.10/PACM.12, PA 12.10/MACM.14, PA 12.10/PACM.14, PA 12.10/MACM.18, PA 12.10/PACM.18, PA 12.12/MACM.10, PA 12.12/PACM.10, PA 12.12/MACM.12, PA 12.12/PACM.12, PA 12.12/MACM.14, PA 12.12/PACM.14, PA 12.12/MACM.18, PA 12.12/PACM.18, PA 10.14/PACM.10, PA 10.14/MACM.12, PA 10.14/PACM.12, PA 10.14/MACM.14, PA 10.14/PACM.14, PA 10.14/MACM.18, PA 10.14/PACM.18, PA 12.14/MACM.10, PA 12.14/PACM.10, PA 12.14/MACM.12, PA 12.14/PACM.12, PA 12.14/MACM.14, PA 12.14/PACM.14, PA 12.14/MACM.18 or PA 12.14/PACM.18.

The polyamides of the range Rilsan® CLEAR from Arkema may notably be used.

In the composition according to the invention, the average number of carbon atoms (C) relative to the nitrogen atom (N) of the semi-crystalline polyamide (or, when the composition comprises a mixture of semi-crystalline polyamides, of at least one of the semi-crystalline polyamides, or even each of the semi-crystalline polyamides) may be greater than or equal to 9, preferably greater than or equal to 10, more preferably greater than or equal to 11, the amorphous polyamide (or when the composition comprises a mixture of amorphous polyamides, at least one of the amorphous polyamides, or even each of the amorphous polyamides) being selected from among any of the polyamides defined above, and in particular selected from among the amorphous polyamides of the embodiments described above. The semi-crystalline polyamide may notably be PA 11, PA 10.10, PA 10.12, PA 12.12, PA 10.14 or PA 12.14, or, when the composition comprises a mixture of semi-crystalline polyamides, at least one of the semi-crystalline polyamides may notably be PA 11, PA 10.10, PA 10.12, PA 12.12, PA 10.14 or PA 12.14, or even each of the semi-crystalline polyamides may independently be selected from among PA 11, PA 10.10, PA 10.12, PA 12.12, PA 10.14 or PA 12.14. Preferably, the semi-crystalline polyamide is PA 11, or, when the composition comprises a mixture of semi-crystalline polyamides, at least one of the semi-crystalline polyamides is PA 11.

Preferably, the semi-crystalline polyamide of the composition, or when the composition comprises a mixture of semi-crystalline polyamides, at least one of the semi-crystalline polyamides, or even each of the semi-crystalline polyamides, is a semi-crystalline polyamide for which the average number of carbon atoms (C) relatively to the nitrogen atom (N) is equal to 11, notably PA 11 or PA 10.12, typically PA 11.

In the composition according to the invention, when the amorphous polyamide is PA MACM.12 (B.12), the semi-crystalline polyamide is not a PA 12. When the composition comprises a mixture of amorphous polyamides, one of them being PA MACM.12 (B.12), the semi-crystalline polyamide may be PA 12 (or the mixture of semi-crystalline polyamides may comprise a PA 12). In an embodiment, when the composition comprises a mixture of amorphous polyamides, one of which being PA MACM.12 (B.12), the semi-crystalline polyamide is not PA 12 or the mixture of semi-crystalline polyamides is without any PA 12.

Preferably, in the composition according to the invention, when the amorphous polyamide is a homopolyamide or when the mixture of amorphous polyamides comprises a homopolyamide, the semi-crystalline polyamide is not PA 12 or the mixture of semi-crystalline polyamides is without any PA 12.

More preferably, in the composition according to the invention, the semi-crystalline polyamide is not PA 12 or the mixture of semi-crystalline polyamides is without any PA 12 (regardless of the amorphous polyamide or of the mixture of amorphous polyamides).

In an embodiment, the composition according to the invention is without any PA 12.

In order to ensure good properties (flexibility, burst resistance, tear resistance, rheology, alloy morphology, compatibilization, homogeneity, consistency, adhesion) and, in particular good properties of impact resistance and impact resistance after ageing (notably high temperature oxidative ageing), it is possible to add to the composition an impact modifier of an elastomeric nature and preferentially polar.

Thus, the composition may comprise up to 20% by weight, based on the total weight of the composition, of an impact modifier formed by a non-rigid polymer having a flexure modulus of less than 100 MPa measured according to the ISO 178 standard as of 2010.

This non-rigid polymer is preferably as flexible as possible and has a glassy transition temperature Tg as low as possible, i.e. less than 0° C. This impact modifier is if need be chemically functionalized so as to be able to react with the amorphous polyamide and/or the semi-crystalline polyamide and to form an alloy compatible with each other.

The impact modifier preferably consists of one or several polyolefins, a portion or the whole of the latter bearing a function selected from among carboxylic acid, carboxylic anhydride, epoxide functions and any other function which may chemically react with polyamides, typically with its amine chain ends (case of carboxylic acid, carboxylic anhydride) or its acid chain ends (case of epoxide, in particular glycidyl methacrylate). For example, the polyolefin is selected from among: a copolymer of ethylene and propylene with an elastomeric nature (EPR), an ethylene-octene copolymer, an ethylene-propylene-diene copolymer with an elastomeric nature (EPDM) and an ethylene/alkyl (meth)acrylate copolymer, for example an anhydride-grafted EPR such as Exxelor VA1803 of Exxon, or the copolymer of polyethylene, ethyl acrylate and maleic anhydride (coPE/EA/MAH) such as Lotader 4700 from Arkema.

The composition may contain fibers, in particular aramide fibers, glass fibers, carbon fibers, advantageously glass fibers, and generally up to a content of 50% by weight, based on the total weight of the composition.

The composition according to the invention may also comprise usual additives of polyamides, such as: coloring agents, light (UV) stabilizers and/or heat stabilizers, plasticizers, surfactants, pigments, optical brighteners, anti-oxidants, natural waxes, mold-removal agents, fillers and mixtures thereof.

The fillers which are contemplated include standard mineral fillers such as those selected from the group, given as non-limiting, comprising talcum, kaolin, magnesia, slags, silica, carbon black, carbon nanotubes, expanded graphite or not, titanium oxide.

The contemplated fillers used with polymers are phenols, phosphites, UV absorbers, stabilizers of the HALS (Hindered Amine Light Stabilizer) type, metal iodides. Mention may be made of Irganox 1010, 245, 1098, Irgafos 168, 126, Tinuvin 312, 770, Iodide P201 from Ciba, Nylostab S-EED from Clariant.

Preferably, the additives of the composition according to the present invention may be present in an amount of less than or equal to 10%, and preferably less than 5% by weight based on the weight of the composition.

In an embodiment, the composition consists of a mixture of:
50 to 95% by weight, notably 60 to 90% by weight, preferably from 65 to 85% by weight of an amorphous polyamide or of a mixture of amorphous polyamides,
5 to 50% by weight, notably 10 to 40% by weight, preferably from 15 to 35% by weight of a semi-crystalline polyamide for which the average number of carbon atoms (C) relatively to the nitrogen atom (N) is greater than or equal to 8, or of a mixture of semi-crystalline polyamides wherein the average number of carbon atoms (C) relatively to the nitrogen atom (N) of each of the semi-crystalline polyamides is greater than or equal to 8,
provided that when the amorphous polyamide is PA MACM.12 (B.12), the semi-crystalline polyamide is not a PA 12,
from 0 to 10% by weight, notably from 0 to 5% by weight of an impact modifier, notably as defined above,
from 0 to 10% by weight, notably 0 to 5% by weight of additives, notably as defined above, and
from 0 to 50% by weight, notably from 0 to 30% by weight of fibers, notably as defined above.

Preferably, the water absorption rate at 23° C. in an atmosphere for which the relative humidity is 50% as measured according to the ISO 62 standard revised in 2011 of the composition according to the invention is at least 10% lower, notably 15% lower, or even 20% lower, than the theoretical water absorption rate obtained by computation by adding the water absorption rates measured for each of the ingredients of the composition in the mass proportion of each of the ingredients of the composition.

Preferably, the water absorption rate at 23° C. in an atmosphere for which the relative humidity is 50% as measured according to the ISO 62 standard revised in 2011 of the composition according to the invention is at least 20% lower, notably 25% lower, or even 30% lower than that of the amorphous polyamide or of the mixture of amorphous polyamides which it contains.

According to a second object, the invention relates to a method for preparing the composition as defined above. According to this method, the composition may be prepared by any method which gives the possibility of obtaining a homogenous mixture containing the composition according to the invention, and optionally other additives, such as extrusion in the molten state, compacting, or further roller kneading.

More particularly, the composition according to the invention may be prepared by mixing in the molten state all the ingredients in a so called direct method. The composition according to the invention may also be prepared as a dry blend. Advantageously, the composition may be obtained as granules, generally by compounding on a tool known to one skilled in the art such as: a twin screw extruder, a co-kneader, an internal mixer.

The composition according to the invention obtained by the preparation method described above may then be transformed for a subsequent use or transformation known to one skilled in the art, notably by injection, calendaring, extrusion, or preferably by injection. The transformation may be directly carried out from the mixture in the molten state or from the dry mixture.

The composition according to the invention is useful for preparing an article, typically by injection, extrusion, co-extrusion, multi-injection, preferably by injection. The preparation method for the composition according to the invention may also use a twin-screw extruder supplying, without any intermediate granulation, an injection press or an extruder according to an application device known to one skilled in the art.

According to a third object, the invention relates to a shaped article, such as a fiber, a fabric, a film, a sheet, a ring, a tube, an injected part, comprising the composition as defined above. Thus, the composition according to the present invention is advantageous for manufacturing articles, in particular articles or article elements for sport, which notably has to have both good transparency, good impact resistance and good endurance to mechanical, chemical, UV, thermal aggressions. Among these sports articles, mention may be made of sports shoe elements, sports utensils such as ice skates or other winter sports and mountain climbing articles, ski bindings, rackets, sports bats, boards, horse shoes, flippers, golf balls, leisure vehicles, in particular those intended for activities in cold weather. Mention may also be made generally of leisure articles, do-it-yourself articles, tools and roadwork equipment subject to climate and mechanical aggressions, protective articles, such as helmet visors, goggles, as well as spectacle arms. Mention may also be made, as non-limiting examples, of car elements, such as headlight covers, rearview mirrors, small parts of off-road vehicles, tanks, in particular of mopeds, motor bicycles, scooters, subject to mechanical and chemical aggressions, screws, cosmetic articles subject to mechanical and chemical aggressions, lipsticks, pressure gauges, esthetical protective elements such as gas cylinders. Mention may also be made of objects or parts of objects for electronics requiring observance of the dimensions, for example parts of mobile phones, of computers, of tablets . . . .

According to a fourth object, the invention relates to the use of a semi-crystalline polyamide for which the average number of carbon atoms (C) relatively to the nitrogen atom (N) is greater than or equal to 8, or of a mixture of semi-crystalline polyamides wherein the average number of carbon atoms (C) relatively to the nitrogen atom (N) of each of the semi-crystalline polyamides is greater than or equal to 8, in a composition comprising an amorphous polyamide or a mixture of amorphous polyamides for improving the dimensional stability of said composition, provided that, when the amorphous polyamide is PA MACM.12, the semi-crystalline polyamide is not a PA 12.

In this use, when the amorphous polyamide is PA MACM.12 (B.12), the semi-crystalline polyamide is not a PA 12. When the composition comprises a mixture of amorphous polyamides for which one of them is PA MACM.12 (B.12), the semi-crystalline polyamide used may be PA 12 (or the mixture of semi-crystalline polyamides used may comprise a PA 12). In an embodiment, when the composition comprises a mixture of amorphous polyamides for which one of them is PA MACM.12 (B.12), the semi-crystalline polyamide used is not a PA 12 or the mixture of semi-crystalline polyamides used is without any PA 12.

Preferably, in this use, when the amorphous polyamide is a homopolyamide or when the mixture of amorphous polyamides comprises a homopolyamide, the semi-crystalline polyamide used is not a PA 12 or the mixture of semi-crystalline polyamides used without any PA 12.

More preferably, in this use, the semi-crystalline polyamide used is not a PA 12 or the mixture of semi-crystalline polyamides used is without any PA 12 (regardless of the amorphous polyamide or of the mixture of amorphous polyamides).

Improvement in the dimensional stability is notably observed for a composition at a temperature of −10° C. with Tg=−20° C., wherein Tg is the glassy transition temperature of the composition measured by DSC according to the ISO 11357-1 standard as of 2009 and ISO 11357-2 standard as of 2013 at a heating rate of 20K/min, preferably in the range of temperatures of use of the part, for example at room temperature (23° C.).

This improvement in the dimensional stability may notably be shown by comparing:
the water absorption rate τ_{composition according to the invention} at a given temperature and at a given relative humidity level of a composition comprising an amorphous polyamide or a mixture of amorphous polyamides and a semi-crystalline polyamide for which the average number of carbon atoms (C) relatively to the nitrogen atom (N) is greater than or equal to 8 or a mixture of semi-crystalline polyamides wherein the average number of carbon atoms (C) relatively to the nitrogen atom (N) of each of the semi-crystalline polyamides is greater than or equal to 8, and
the water absorption rate τₐₘₒᵣₚₕₒᵤₛ at the same temperature and at the same humidity level of the amorphous polyamide or of the mixture of amorphous polyamides present in said composition,
   and by observing that τ_{composition according to the invention}<τₐₘₒᵣₚₕₒᵤₛ.
   Typically, τ_{composition according to the invention} at 23° C. in water measured according to the ISO 62 standard revised in 2011 is at least 25% lower, notably 30% lower, or even 35% lower, than τₐₘₒᵣₚₕₒᵤₛ.
   Also, τ_{composition according to the invention} at 23° C. in an atmosphere for which the relative humidity is 50% as measured according to the ISO 62 standard revised in 2011 is at least 35% lower, notably 40% lower than τₐₘₒᵣₚₕₒᵤₛ,
   or else by comparing:
the water absorption rate τ_{composition according to the invention} at a given temperature and at a given relative humidity level of a composition comprising an amorphous polyamide or a mixture of amorphous polyamides and of a semi-crystalline polyamide, for which the average number of carbon atoms (C) relatively to the nitrogen atom (N) is greater than or equal to 8 or a mixture of semi-crystalline polyamides wherein the average number of carbon atoms (C) relatively to the nitrogen atom (N) of each of the semi-crystalline polyamides is greater than or equal to 8, and
the water absorption rate τ_{theory} at the same temperature and at the same humidity level obtained by computation by adding the water absorption rates measured for each of the ingredients of said composition in the mass proportion of each of the ingredients of said composition,
   and by observing τ_{composition according to the invention}<τ_{theory}.
   Typically, τ_{composition according to the invention} at 23° C. in the water, measured according to the ISO 62 standard revised in 2011 is at least 10% lower, notably 15% lower, or even 20% lower than τ_{theory}.
   Also, τ_{composition according to the invention} at 23° C. in an atmosphere for which the relative humidity is 50% as measured according to the ISO 62 standard revised in 2011 is at least 20% lower, notably 25% lower than τ_{theory}.

The water absorption rate may for example be measured in an atmosphere for which the relative humidity is 50%, or in water, according to the ISO 62 standard revised in 2011.

The embodiments described above (polyamides, notably average number of carbon atoms (C) relatively to the nitrogen atom (N) of the semi-crystalline polyamide, proportions, other ingredients in the composition . . . ) are of course applicable.

The invention also relates to a method for improving the dimensional stability of a composition comprising an amorphous polyamide or a mixture of amorphous polyamides comprising a step consisting of adding to said composition a semi-crystalline polyamide for which the average number of carbon atoms (C) relatively to the nitrogen atom (N) is greater than or equal to 8, or a mixture of semi-crystalline polyamides wherein the average number of carbon atoms (C) relatively to the nitrogen atom (N) of each of the semi-crystalline polyamides is greater than or equal to 8, provided that, when the amorphous polyamide is PA MACM.12, the semi-crystalline polyamide is not a PA 12.

According to a fifth object, the invention relates to the use of a semi-crystalline polyamide for which the average number of carbon atoms (C) relatively to the nitrogen atom (N) is greater than or equal to 8, or of a mixture of semi-crystalline polyamides wherein the average number of carbon atoms (C) relatively to the nitrogen atom (N) of each of the semi-crystalline polyamides is greater than or equal to 8, in a composition comprising an amorphous polyamide or a mixture of amorphous polyamides for reducing the water absorption rate of said composition, provided that, when the amorphous polyamide is PA MACM.12, the semi-crystalline polyamide is not a PA 12.

Preferably, in this use, when the amorphous polyamide is a homopolyamide, the semi-crystalline polyamide is not a PA 12.

More preferably, in this use, the semi-crystalline polyamide is not a PA 12 (regardless of the amorphous polyamide).

The reduction in the water absorption rate is notably observed for a composition at a temperature of −10° C. with Tg −20° C. (wherein Tg is the glassy transition temperature of the composition measured by DSC according to the ISO 11357-1 standard as of 2009 and ISO 11357-2 standard as of 2013 at a heating rate of 20K/min), preferably at room temperature (23° C.).

The embodiments described above (polyamides, proportions, other ingredients in the composition . . . ) are of course applicable.

The invention also relates to a method for reducing the water absorption rate of a composition comprising an amorphous polyamide or a mixture of amorphous polyamides comprising a step consisting of adding to said composition a semi-crystalline polyamide for which the average number of carbon atoms (C) relatively to the nitrogen atom (N) is greater than or equal to 8, or a mixture of semi-crystalline polyamides wherein the average number of carbon atoms (C) relatively to the nitrogen atom (N) of each of the semi-crystalline polyamides is greater than or equal to 8, provided that, when the amorphous polyamide is PA MACM.12, the semi-crystalline polyamide is not a PA 12.

The invention is illustrated with the following examples, which are provided as non-limiting examples.

In the examples below, plates of 100*100*1 mm³ were prepared by injecting a polymeric composition obtained following a compounding phase.

The water absorption rate at 23° C. of polymeric compositions were measured, either in an atmosphere for which the relative humidity level (RH) was 50%, or in water, following the method described in the ISO 62 standard revised in 2011. The provided water absorption rates are in equilibrium. The water absorption was followed by successive weighing operations until saturation was attained.

For polymeric compositions, the tables below show the water absorption rate measured and the theoretical water absorption rate obtained by computation by adding the water absorption rates measured for each of the polymers of the polymeric composition in the mass proportion of each of the polymers of the polymeric composition.

Thus, the theoretical water absorption rate of a polymeric composition comprising x % by weight of a polymer X for which the water absorption rate is Tₓ and y % by weight of a polymer Y for which the water absorption rate is T_{y} is xTₓ+yT_{y}.

All the polymers come from Arkema.

The proportions are by weight based on the total weight of the composition.

### COMPARATIVE EXAMPLE 1: ORGALLOY® (A POLYMERIC COMPOSITION COMPRISING 64% OF PA6 AND A MIXTURE OF FUNCTIONAL POLYOLEFIN (FPO) AND OF NON-FUNCTIONAL POLYOLEFIN)

The water absorption rates are provided in table 1.

TABLE 1
water absorption rates

| | Water absorption, 23° C. in water | | | Water absorption, 23° C. at 50% RH | | |
|---|---|---|---|---|---|---|
| | | | measurement/theory | | | measurement/theory |
| | measured | theoretical | deviation | measured | theoretical | deviation |
| PA 6 | 9.5% | NA | NA | 3% | NA | NA |
| Orgalloy ® | 6% | 6.1% | 2% | 1.8% | 1.9% | 5% |

NA: non-applicable

The theoretical and measured water absorption rates of Orgalloy are substantially identical, as expected. Each of the polymers of the polymeric composition absorbs water without being influenced by its environment.

### COMPARATIVE EXAMPLE 2: POLYMERIC COMPOSITION COMPRISING PA11 AND 8% OF GLASS FIBERS

The water absorption rates are provided in table 2.

TABLE 2
water absorption rates

| | Water absorption, 23° C. in water | | |
|---|---|---|---|
| | | | measurement/ |
| | measured | theoretical | theory deviation |
| PA 11 + 8% of glass fibers | 1.6% | 1.66% | 4% |

The theoretical and measured water absorption rates of a polymeric composition comprising PA11 and 8% of glass fibers are substantially identical, as expected. Each of the ingredients of the polymeric composition absorbs water without being influenced by its environment.

### EXAMPLE 1: MIXTURE OF PA 12/MACM.I/MACM.T AND OF PA11

The water absorption rates are provided in tables 3 and 4.

TABLE 3
water absorption rate at 23° C. at 50% RH

| | Water absorption, 23° C. at 50% RH | | | |
|---|---|---|---|---|
| | | | deviation | deviation |
| | | theoretical | τ_{composition according to the invention}/ | τ_{composition according to the invention}/ |
| | measured | (=τ_{theory)} | τ_{theory} | τₐₘₒᵣₚₕₒᵤₛ |
| 12/MACM.I/MACM.T | 1.4% | NA | NA | 0% |
| | (=τₐₘₒᵣₚₕₒᵤₛ₎ | | | |
| 70% 12/MACM.I/MACM.T + | 0.9% | 1.2% | 25% | 36% |
| 30% PA11 | (=τ_{composition according to the invention)} | | | |
| 60% 12/MACM.I/MACM.T + | 0.8% | 1.0% | 20% | 43% |
| 25% PA11 + 15% of | (=τ_{composition according to the invention)} | | | |
| glass fibers | | | | |
| 68% 12/MACM.I/MACM.T + | 0.8% | 1.1% | 27% | 43% |
| 17% PA11 + 15% of | (=τ_{composition according to the invention)} | | | |
| glass fibers | | | | |

NA: non-applicable

TABLE 4
water absorption rates in water at 50% RH

| | Water absorption, 23° C. in water | | | |
|---|---|---|---|---|
| | | | deviation | deviation |
| | | theoretical | τ_{composition according to the invention}/ | τ_{composition according to the invention}/ |
| | measured | (=τ_{theory)} | τ_{theory} | τₐₘₒᵣₚₕₒᵤₛ |
| 12/MACM.I/MACM.T | 3.3% | NA | NA | 0% |
| | (=τₐₘₒᵣₚₕₒᵤₛ₎ | | | |
| 70% 12/MACM.I/MACM.T + | 2.4% | 2.9% | 17% | 27% |
| 30% PA11 | (=τ_{composition according to the invention)} | | | |
| 60% 12/MACM.I/MACM.T + | 2.0% | 2.5% | 20% | 39% |
| 25% PA11 + 15% of | (=τ_{composition according to the invention)} | | | |
| glass fibers | | | | |
| 68% 12/MACM.I/MACM.T + | 2.1% | 2.6% | 19% | 36% |
| 17% PA11 + 15% of | (=τ_{composition according to the invention)} | | | |
| glass fibers | | | | |

The polymeric compositions comprising an amorphous PA (12/MACM.I/MACM.T), a semi-crystalline polyamide with a long chain (PA 11) and optionally glass fibers absorb less water than predicted by the computation (20 to 27% less in an atmosphere with 50% RH and 17 to 20% less in water).

Also, the polymeric compositions comprising an amorphous PA (12/MACM.I/MACM.T), a semi-crystalline polyamide with long chain (PA 11) and optionally glass fibers absorb less water than 12/MACM.I/MACM.T (36 to 43% in an atmosphere at 50% RH and 27 to 36% less in water).

The dimensional stability of these polymeric compositions will therefore be improved as compared with amorphous PA (12/MACM.I/MACM.T) and significantly greater than the expected one.

### EXAMPLE 2: MIXTURE OF PA 12/MACM.I/MACM.T, OF PA 11/MACM.10 AND OF PA11

The water absorption rates are provided in table 5.

TABLE 5
water absorption rates

| | Water absorption, 23° C. at 50% RH | | |
|---|---|---|---|
| | | | deviation |
| | measured | theoretical | τ_{composition according to the invention/} |
| | (=τ_{composition according to the invention)} | (=τ_{theory)} | τ_{theory} |
| 37.8% 12/MACM.I/MACM.T + 28% | 0.8% | 1.06% | 25% |
| 11/MACM.10 + 16.9% PA11 + 2% Renol | | | |
| Blue + 15% of glass fibers (S-2 from AGY) + | | | |
| 0.1% of Irganox + 0.2% of Irgafos 168 | | | |
| 38.1% 12/MACM.I/MACM.T + 23.4% | 0.8% | 1.02% | 22% |
| 11/MACM.10 + 21.2% PA11 + 2% Renol | | | |
| Blue + 15% of glass fibers (S-2 from AGY) + | | | |
| 0.1% of Irganox + 0.2% of Irgafos 168 | | | |

The polymeric compositions comprising two amorphous PAs (12/MACM.I/MACM.T and 11/MACM.10) and a semi-crystalline polyamide with a long chain (PA11) absorb less water than predicted by the computation (22 to 25% less in an atmosphere at 50% RH).

The dimensional stability of these polymeric compositions will therefore be improved and significantly greater than the expected one.

1. Method for improving the dimensional stability of a composition comprising an amorphous polyamide or a mixture of amorphous polyamides comprising a step consisting of adding to said composition a semi-crystalline polyamide, for which the average number of carbon atoms (C) relatively to the nitrogen atom (N) is greater than or equal to 8, or of a mixture of semi-crystalline polyamides wherein the average number of carbon atoms (C) relatively to the nitrogen atom (N) of each of the semi-crystalline polyamides is greater than or equal to 8, provided that, when the amorphous polyamide is PA MACM.12, the semi-crystalline polyamide is not a PA 12.

2. The method according to claim 1, wherein the composition comprises:
50 to 95% by weight of the amorphous polyamide or of the mixture of amorphous polyamides, and
5 to 50% by weight of the semi-crystalline polyamide or of the mixture of semi-crystalline polyamides.

3. The method according to claim 2, wherein the composition comprises:
60 to 90% by weight of the amorphous polyamide or of the mixture of amorphous polyamides, and
10 to 40% by weight of the semi-crystalline polyamide or of the mixture of semi-crystalline polyamides.

4. The method according to claim 1, wherein:
the semi-crystalline polyamide or at least one semi-crystalline polyamide of the mixture of semi-crystalline polyamides, and/or
the amorphous polymer or at least one amorphous polyamide of the mixture of amorphous polyamides,
comprises a unit obtained from a lactam.

5. The method according to claim 1, wherein:
the semi-crystalline polyamide or at least one semi-crystalline polyamide of the mixture of semi-crystalline polyamides, and/or
the amorphous polymer or at least one amorphous polyamide of the mixture of amorphous polyamides,
comprises a unit obtained from an amino acid.

6. The method according to claim 1, wherein:
the semi-crystalline polyamide or at least one semi-crystalline polyamide of the mixture of semi-crystalline polyamides, and/or
the amorphous polymer or at least one amorphous polyamide of the mixture of amorphous polyamides,
comprises a unit fitting the formula (Ca diamine).(Cb diacid), with a representing the number of carbon atoms of the diamine and b representing the number of carbon atoms of the diacid, a and b being each independently comprised between 4 and 36.

7. The method according to claim 6, wherein the Ca diamine is:
either a linear and aliphatic diamine of formula:
H₂N—(CH₂)ₐ—NH₂
wherein a is an integer comprised between 4 and 36,
or a cycloaliphatic diamine of formula: 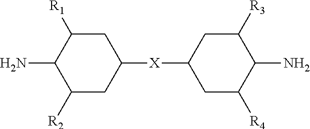
wherein:
R₁, R₂, R₃ and R₄ represent independently a group selected from among a hydrogen atom or an alkyl with 1 to 6 carbon atoms and
X represents either a simple bond, or a divalent group consisting of:
a linear or branched aliphatic chain comprising from 1 to 10 carbon atoms, optionally substituted with cycloaliphatic or aromatic groups with 6 to 8 carbon atoms,
of a cycloaliphatic group with 6 to 12 carbon atoms.

8. The method according to claim 6, wherein the Ca diamine is selected from among:
a linear and aliphatic Ca diamine selected from among butanediamine (a=4), pentanediamine (a=5), hexanediamine (a=6), heptanediamine (a=7), octanediamine (a=8), nonanediamine (a=9), decanediamine (a=10), undecanediamine (a=11), dodecanediamine (a=12), tridecanediamine (a=13), tetradecanediamine (a=14), hexadecanediamine (a=16), octadecanediamine (a=18), octadecanediamine (a=18), eicosanediamine (a=20), docosanediamine (a=22) and the diamines obtained from fatty acids,
a cycloaliphatic diamine selected from among bis(3,5-dialkyl-4-aminocyclohexyl)methane, bis(3,5-dialkyl-4-aminocyclohexyl) ethane, bis(3,5-dialkyl-4-aminocyclohexyl)propane, bis(3,5-dialkyl-4-aminocyclohexyl)butane, bis-(3-methyl-4-aminocyclohexyl)-methane, p-bis(aminocyclohexyl)methane and bis(aminocyclohexyl)propane, and
an alkylaromatic diamine selected from among 1,3-xylylene diamine and 1,4-xylylene diamine.

9. The method according to claim 6, wherein the Cb diacid is selected from among:
a linear aliphatic diacid selected from among succinic acid (b=4),), pentanedioic acid (b=5), adipic acid (b=6), heptanedioic acid (b=7), octanedioic acid (b=8), azelaic acid (b=9), sebacic acid (b=10), undecanedioic acid (b=11), dodecanedioic acid (b=12), brassylic acid (b=13), tetradecanedioic acid (b=14), hexadecanedioic acid (b=16), octadecanoic acid (b=18), octadecenedioic acid (b=18), eicosanedioic acid (b=20), docosanedioic acid (b=22) and dimers of fatty acids containing 36 carbons, and
an aromatic diacid selected from among terephthalic acid, isophthalic acid, and naphthalenic diacid.

10. The method according to claim 1, wherein the semi-crystalline polyamide, or at least one semi-crystalline polyamide of the mixture of semi-crystalline polyamides, is a homopolyamide.

11. The method according to claim 1, wherein the average number of carbon atoms (C) relatively to the nitrogen atom (N) of the semi-crystalline polyamide, or at least of a semi-crystalline polyamide of the mixture of semi-crystalline polyamides, is greater than or equal to 9.

12. The method according to claim 11, wherein the average number of carbon atoms (C) relatively to the nitrogen atom (N) of the semi-crystalline polyamide, or of at least one semi-crystalline polyamide of the mixture of semi-crystalline polyamides, is equal to 11.

13. The method according to claim 12, wherein the semi-crystalline polyamide, or at least one semi-crystalline polyamide of the mixture of semi-crystalline polyamides, is PA11.

14. The method according to claim 1, wherein the composition has a water absorption rate at 23° C. in water measured according to the ISO 62 standard revised in 2011 at least 25% less than that of the amorphous polyamide or of the mixture of amorphous polyamides which it contains.

15. The method according to claim 1, wherein the composition has a water absorption rate at 23° C. in an atmosphere for which the relative humidity is 50% as measured according to the ISO 62 standard revised in 2011 at least 35% less than that of the amorphous polyamide or of the mixture of amorphous polyamides which it contains.

16. The method according to claim 1, wherein the composition has a water absorption rate at 23° C. in water as measured according to the ISO 62 standard revised in 2011 at least 10% less than the theoretical water absorption rate obtained by computation by adding the water absorption rates measured for each of the ingredients of the composition in the mass proportion of each of the ingredients of the composition.

17. The method according to claim 1, wherein the composition has a water absorption rate at 23° C. in an atmosphere for which the relative humidity is 50% as measured according to the ISO 62 standard revised in 2011 at least 20% less than the theoretical water absorption rate obtained by computation by adding the water absorption rates measured for each of the ingredients of the composition in the mass proportion of each of the ingredients of the composition.

18. The method according to claim 4, wherein the lactam is selected from among pyrrolidinone, piperidinone, caprolactam, enantholactam, caprylolactam, pelargolactam, decanolactam, undecanolactam, and laurolactam.

19. The method according to claim 5, wherein the amino acid is selected from among 9-aminononanoic acid, 10-aminodecanoic acid, 12-aminododecanoic acid, 11-aminoundecanoic acid and N-heptyl-11-aminoundecanoic acid.

20. The method according to claim 6, wherein the Ca diamine is aliphatic, cycloaliphatic or alkylaromatic and/or the Cb diacid is aliphatic, cycloaliphatic or aromatic.
